(19) United States
(12) Patent Application Publication
(10) Pub. No.: US 2025/0216212 A1
(43) Pub. Date: Jul. 3, 2025

(54) Method for Supporting a Driver of a Vehicle in Travelling a Predetermined Route, Computer-Readable (Storage) Medium, and Assistance System for a Vehicle

(71) Applicant: Bayerische Motoren Werke Aktiengesellschaft, Muenchen (DE)

(72) Inventors: Patrick EBNER, Wessling OT Oberpfaffenhofen (DE); Uwe PROEMM, Eggstaett (DE); Hubert SCHOLZ, Muenchen (DE); Martin SEDLMAYR, Wessobrunn (DE)

(21) Appl. No.: 18/850,106

(22) PCT Filed: Mar. 8, 2023
(86) PCT No.: PCT/EP2023/055825

§ 371 Date: Sep. 24, 2024

(30) Foreign Application Priority Data
Apr. 13, 2022 (DE) 10 2022 109 157.0

(51) Int. Cl. G01C 21/36

(52) U.S. Cl. CPC G01C 21/3626

(57) ABSTRACT

A method for supporting a driver of a vehicle in travelling a predetermined route in traffic, including a receiving of route data which describes at least one upcoming curve of the predetermined route to be travelled by the vehicle by a curve radius. The method also includes determining a curve threshold speed and/or a lateral acceleration threshold, wherein the curve threshold speed or the lateral acceleration threshold describes a maximum curve speed or a maximum lateral acceleration according to the curve radius. Application characteristic curve data is used to determine the curve threshold speed and/or the lateral acceleration threshold, wherein the application characteristic curve data describes a driving-style-specific relationship between a lateral acceleration and a vehicle speed.

### BACKGROUND AND SUMMARY

The present invention relates to a method for supporting a driver of a vehicle in traveling a predetermined route in road traffic, in particular for determining a curve limiting speed and/or a lateral limiting transverse acceleration. In addition, the present invention relates to a computing device for a vehicle for carrying out such a method. Finally, the present invention relates to a computer-readable (storage) medium and an assistance system for a vehicle.

Vehicles often already have navigation systems as a standard feature presently. Navigation systems based on global navigation satellite systems can navigate the driver to his desired destination. A map database of the navigation system can moreover be used to inform the driver of the vehicle about the route. Information about upcoming curves can be presented to the driver of the vehicle here. Furthermore, the driver can be warned if a reduction of the current speed is recommended in any curves. However, for this purpose it is necessary to output an assessment about resulting hazards on the basis of the predetermined route or the map data, in particular the speed at which an upcoming curve can be traveled.

Document DE 10 2005 021 448 A1 provides a system and a method for warning a driver about upcoming curves of the road. In general, a vehicle position determination module determines the vehicle position in a global positioning system (GPS), and a map comparison module determines the vehicle position on a map on the basis of the position in the global positioning system. A forecast module searches in the forward direction on the map for a curve, ascertains a candidate list of the possible driving paths through the curve, and determines the most probable path of the vehicle through the curve on this candidate list. A warning module then assesses the hazard for the vehicle originating from the curve.

The current prior art does enable the output of a warning of potentially critical curves, but no solution is disclosed for how an optimum curve limiting speed can be determined. The current prior art therefore also does not disclose a solution for how the driver of a vehicle can be supported individually and in the best possible manner in traveling a curve.

It is therefore the object of the present invention to disclose a solution for how a driver can be supported individually and in the best possible manner in traveling a predetermined (curvy) route—beyond the prior art.

This object is achieved according to the invention by a method, by a computing device, by a computer-readable (storage) medium, and by an assistance system having the features according to the independent claims. Advantageous refinements of the present invention are specified in the dependent claims.

A method according to the invention for supporting a driver of a vehicle in traveling a predetermined route in road traffic comprises receiving route data, which describe at least one curve of the predetermined route to be traveled in future by the vehicle by means of a curve radius. In addition, the method according to the invention comprises determining a curve limiting speed and/or a lateral limiting transverse acceleration, wherein the curve limiting speed or the lateral limiting transverse acceleration describes a maximum curve speed or a maximum lateral transverse acceleration as a function of the curve radius. In this case, application characteristic curve data are used to determine the curve limiting speed and/or the lateral limiting transverse acceleration, wherein the application characteristic curve data describe a driving style-specific relationship between a transverse acceleration and a vehicle speed.

In other words, the driver of the vehicle is thus to be supported individually and in a driving style-specific manner in traveling a predetermined route, in particular a route unknown to them. A safer and more predictive driving style can thus be enabled. Optionally, the personal driving style of the driver can in particular also be taken into consideration here.

As described at the outset, route data are initially received for this purpose. The route data can be provided here, for example, by a navigation system, a map database, by means of a vehicle-to-vehicle communication, or the like. The route data describe here in particular a curve of the predetermined route to be traveled in future by the vehicle by means of a curve radius. It is also conceivable here that the curve radius is initially ascertained from the route data. The curve radius can describe the curvature of the curve to be traveled in future. It can thus also be provided that the route data describe the curve of the predetermined route to be traveled in future by means of the curvature. In other words, a curve radius can thus be derived from the curvature. Vice versa, a curvature of the curve to be traveled in future can also be determined starting from the curve radius. Moreover, it is conceivable that the curvature of the curve and the curve radius are determined from individual route points of the predetermined route.

A curve limiting speed and/or a lateral limiting transverse acceleration can be determined based on the curvature or based on the curve radius of the curve of the predetermined route to be traveled in future. It is conceivable here that, for example, a lateral limiting transverse acceleration is determined, since the square of the curve limiting speed is directly proportional thereto. A curve limiting speed can also be determined directly, since a lateral limiting transverse acceleration can be determined therefrom.

It is also conceivable that the curve limiting speed and/or the lateral limiting transverse acceleration is not calculated or determined separately for each curve. Instead, it is conceivable that, for example, no calculation or determination takes place at predetermined (curve radius) support points. In other words, it can thus be provided that a calculation or a determination of the curve limiting speed and/or the lateral limiting transverse acceleration only takes place in an intermediate area of the predetermined (curve radius) support points.

The curve limiting speed describes a maximum curve speed here, which does not necessarily correspond to a maximum physically possible curve speed. In particular, it is thus also conceivable that the curve limiting speed is determined, for example, depending on a personal driving style of the driver and/or depending on a selected driving mode. This also applies in this case to the lateral limiting transverse acceleration, which describes the maximum lateral transverse acceleration, which does not necessarily correspond to the maximum physically possible lateral transverse acceleration. Known driving modes can be, for example, a so-called comfort mode, a sport mode, or an efficient and low consumption eco-pro mode.

The maximum physically possible curve speed or the maximum physically possible lateral transverse acceleration describe here the speed or transverse acceleration which a lateral guidance force acting on the vehicle in the transverse direction and possibly a braking or drive force in the longitudinal direction of the vehicle cause until the maximum friction force is reached. This relationship can be represented by a so-called circle of forces, which describes an idealized relationship between longitudinal and lateral guidance force on the wheel of the vehicle. The maximum physically possible curve speed or the maximum physically possible lateral transverse acceleration are therefore always greater than (or equal to) the curve limiting speed or the lateral limiting transverse acceleration correlated with the curve limiting speed.

The application characteristic curve data, which are used to determine the curve limiting speed and/or the lateral limiting transverse acceleration, describe a driving style-specific relationship between a transverse acceleration and a driving speed. In other words, the application characteristic curve data can describe a personal driving style of the driver here. The application characteristic curve data can also correspond, however, to a driving style selected by the driver—optionally corresponding to a driving mode. In the most general case, the application characteristic curve data can also simply describe an empirically ascertained driving style, which corresponds, for example, to specific customer groups, nationalities, or the like.

A speed-dependent distribution of the transverse acceleration in customer operation is known from the literature, for example. Due to a lower risk consciousness, higher transverse accelerations can occur at lower speeds. Vice versa, it is conceivable that at higher speeds, lower transverse accelerations occur, since the risk consciousness can be higher at higher speeds. This can also be related in particular to the human feeling of a transverse acceleration being dependent on a speed. Furthermore, a speed-dependent distribution of the transverse acceleration can also be based on a (subjectively perceived) reserve desired by the driver. Specifically, for example, at high speeds a braking distance or a distance for speed deceleration can be significantly greater, because of which a reserve for the driver can be desirable. Such relationships can be modeled or mapped by means of the application characteristic curve data.

It is to be emphasized in this case that the application characteristic curve data can comprise individual data points, or also a characteristic curve. In summary, a safer and more predictive driving style adapted to the personal driving style of the driver and/or to a driving mode can thus be enabled by means of the application characteristic curve data. A curve limiting speed, which is determined by means of the method according to the invention, thus also enables a fluid driving experience. In other words, prepared route data which describe the predetermined route are related to a current driving situation. The driver of the vehicle can concentrate here on the actual driving task without being distracted. Warnings on the basis of a curve limiting speed determined in this way can thus be adapted to the speed-dependent feeling of transverse accelerations of the driver.

One advantageous refinement of the method according to the invention provides that in the determination of the curve limiting speed and/or the lateral limiting transverse acceleration, an initial parameter is determined, wherein the initial parameter is dependent on the curve radius. Moreover, it is provided in the advantageous refinement that the determination of the curve limiting speed and/or the lateral limiting transverse acceleration takes place iteratively starting from the initial parameter in consideration of the application characteristic curve data.

The way in which the curve limiting speed or the lateral limiting transverse acceleration is determined can be decisive for a safe and predictive manner of driving, which is moreover fluid and possibly even adapted to the personal driving style of the driver. It is conceivable that a curve limiting speed or a lateral limiting transverse acceleration is stored in a so-called lookup table point-by-point as a function of the curve radius, however, it is also decisive in this case how the values thereof are determined.

According to the method according to the invention, an initial parameter, which can represent a first estimation of the curve limiting speed or the lateral limiting transverse acceleration, can thus initially be determined. The curve limiting speed or the lateral limiting transverse acceleration can then be iteratively determined. In other words, a first estimation (initial parameter) can thus be adapted step-by-step to the personal driving style of the driver and/or a driving mode of the vehicle and/or the like. The curve limiting speed and/or the lateral limiting transverse acceleration can thus be determined optimally. In contrast to the prior art, a warning can thus be output of curves to be traveled in future, which can be oriented to a personal driving style of the driver and/or a driving mode of the vehicle and/or the like. Furthermore, a speed range or a range matching with the curve limiting speed or the lateral limiting transverse acceleration can also be recommended to the driver.

Furthermore, it is advantageous if driving dynamics data are additionally received, which describe at least one current vehicle speed, and a curve criticality of the at least one curve of the predetermined route to be traveled in future by the vehicle is determined as a function of the driving dynamics data and the curve limiting speed and/or the lateral limiting transverse acceleration. It is therefore possible to relate a curve limiting speed and/or a lateral limiting transverse acceleration, which is determined according to the method according to the invention and the advantageous embodiments thereof, to the current driving situation in the form of a curve warning. Predictions of the predetermined route and ACTUAL status variables with the goal of a continuous curve comprehension of the driver can thus be brought into harmony.

Moreover, it is advantageous if the route data describe at least two successive curves to be traveled in future by the vehicle by means of the curve radius and a curve distance, and an overall criticality is determined which depends on the curve criticality of the at least two successive curves and the respective curve distance of the at least two successive curves. If the route data thus describe multiple successive curves, it is possible to provide the driver with a curve forecast in consideration of multiple curves.

The determination of an overall criticality can enable a curve which first follows a further curve to be taken into consideration here when outputting a warning, although the associated curve does not represent the curve to be traveled immediately in future of the predetermined route. The curve distance described by the route data can be decisive in this case. The curve distance can describe, for example, a distance between two successive curves here. The curve distance can also describe a distance between the vehicle and the respective curve, however. The curve distance can be helpful in assessing the curve criticality and in particular in determining the overall criticality.

It is moreover advantageous if additional recommendation data are provided, which describe a speed, wherein the speed range comprises the curve limiting speed. In other words, it is advantageous if a speed range is presented to the driver instead of a single curve limiting speed. The speed range can be adapted here to the personal driving style of the driver, a driving mode, or a driver intention or the like.

Finally, it is also advantageous if the recommendation data additionally or alternatively describe the curve criticality and/or the overall criticality. The attentiveness of the driver can thus be increased and as a result the level of safety can additionally be increased.

A further aspect of the invention relates to a computing device for a vehicle, which is configured to carry out a method according to the invention and the advantageous embodiments thereof. In addition, the present invention relates to a computer program comprising commands which, upon the execution of the program by a computing device, prompt it to carry out a method according to the invention and the advantageous embodiments thereof. Furthermore, the invention relates to a computer-readable (storage) medium, comprising commands which, upon the execution by a computing device, prompt it to carry out a method according to the invention and the advantageous embodiments thereof.

The present invention also relates to an assistance system for a vehicle, comprising a computing device according to the invention, a computer-readable (storage) medium according to the invention, and a notification device, which is configured to output recommendation data provided to the driver as a notification.

One advantageous embodiment of the assistance system according to the invention provides that the notification device is configured to output recommendation data provided to the driver as a notification and to visually display the predetermined route to the driver, wherein a part of the notification is colored depending on the criticality and/or the overall criticality. Specific elements of the notification device, such as signal displays, map data, or the like, can thus be highlighted in color. However, it is also conceivable—in particular if the notification device is designed as a head-up display (optionally having so-called augmented reality functionalities to display an augmented reality)—that roadway markings, artificial notification devices, or the like are highlighted in color.

Furthermore, it is conceivable that a change gradient of the criticality and/or a change gradient of the overall criticality is determined. The change gradient can describe a change of the criticality and/or the overall criticality. In particular, the change gradient can also describe a rate of change of the criticality and/or the overall criticality, i.e., a speed at which the criticality and/or the overall criticality changes. The coloration of the part of the notification can be influenced as a function of the change gradient. For example, it is conceivable that in the case of a positive change gradient, thus, for example, when the criticality and/or the overall criticality increases, a pulsing/flashing coloration of the part of the notification takes place. The driver can thus additionally be made aware of corresponding—changing—hazards and/or hazard levels. Overall, the driving safety can possibly thus be increased.

Finally, the present invention relates to a vehicle, in particular a passenger vehicle, comprising an assistance system according to the invention.

The preferred embodiments presented with respect to the method according to the invention and the advantages thereof apply accordingly to the computing device according to the invention, to the assistance system according to the invention, to the vehicle according to the invention, to the computer program according to the invention, and to the computer-readable (storage) medium according to the invention.

Further features of the invention result from the claims, the figures, and the description of the figures. The features and combinations of features mentioned above in the description and the features and combinations of features mentioned hereinafter in the description of figures and/or shown solely in the figures are usable not only in the respective specified combination, but also in other combinations or alone, without departing from the scope of the invention.

The invention will now be explained in more detail on the basis of preferred exemplary embodiments and with reference to the appended drawings. In the figures:

### BRIEF DESCRIPTION OF THE DRAWINGS

FIG. 1 shows a schematic representation of a vehicle, comprising an assistance system according to the invention,

FIG. 2 shows a schematic representation of application characteristic curve data,

FIG. 3 shows a schematic representation of the iterative determination of the curve limiting speed,

FIG. 4 shows a schematic representation of various driving styles extracted from (idealized) customer data, and

FIG. 5 shows a schematic representation of a predetermined route in road traffic having at least two successive curves, which are described by a curve radius and a curve distance.

### DETAILED DESCRIPTION OF THE DRAWINGS

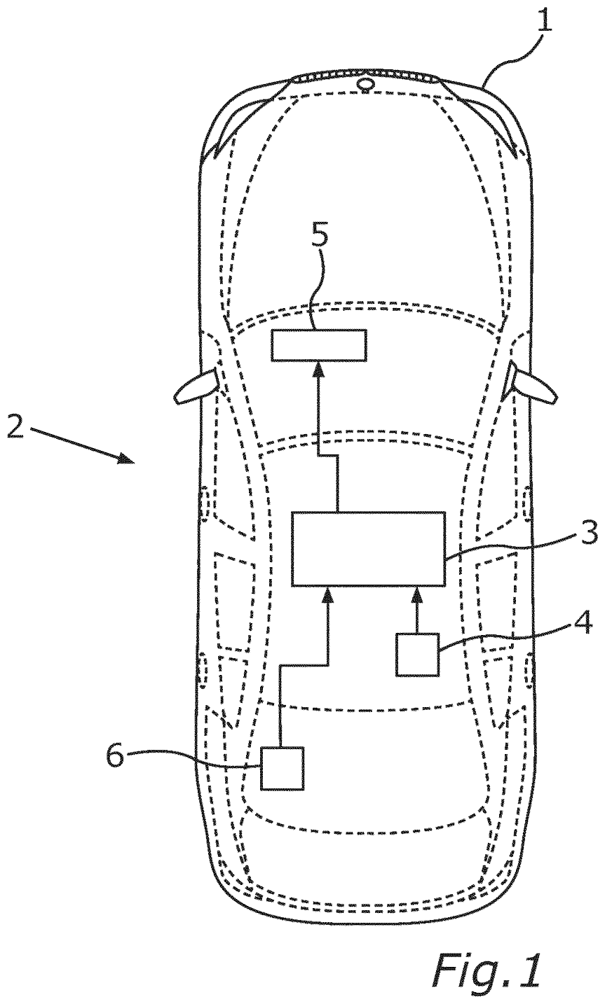

FIG. 1 shows a schematic representation of a vehicle 1, comprising an assistance system 2. The assistance system 2 comprises a computing device 3, a computer-readable (storage) medium 4, and a notification device 5. The vehicle 1 moreover comprises a navigation system 6. The computing device 3 is configured to carry out a method according to the invention for supporting a driver of the vehicle 1 in traveling a predetermined route in road traffic.

In particular, the computing device 3 is thus also configured for determining a curve limiting speed v_{x, limit} and/or a lateral limiting transverse acceleration a_{y, limit}. The computing device 3 can receive route data for this purpose. The route data can be provided, for example, by the navigation system 6. However, it is also conceivable that the navigation system 6 provides position data and the corresponding route data are retrieved, for example, from a central storage unit.

The computing device 3 can determine driving dynamics data from a chronological sequence of the position data provided by the navigation system 6. For example, a vehicle speed can thus be determined. It is also conceivable that any driving dynamics data are provided by a central control unit of the vehicle 1.

Based on the route data, which describe at least a curve of the predetermined route to be traveled in future by the vehicle 1 by means of a curve radius R, a curve limiting speed v_{x, limit} of the curve to be traveled in future can be determined by the computing device 3. Alternatively or additionally, a lateral limiting transverse acceleration a_{y, limit} of the curve to be traveled in future can also be determined. The computing device 3 can output recommendation data to the notification device 5.

The notification device can be designed, for example, as a display or even as a head-up display—optionally having augmented reality functionalities. The recommendation data can here comprise, for example, the curve limiting speed v_{x, limit}, a speed range which comprises the curve limiting speed v_{x, limit}, a curve distance, a curve warning, or the like.

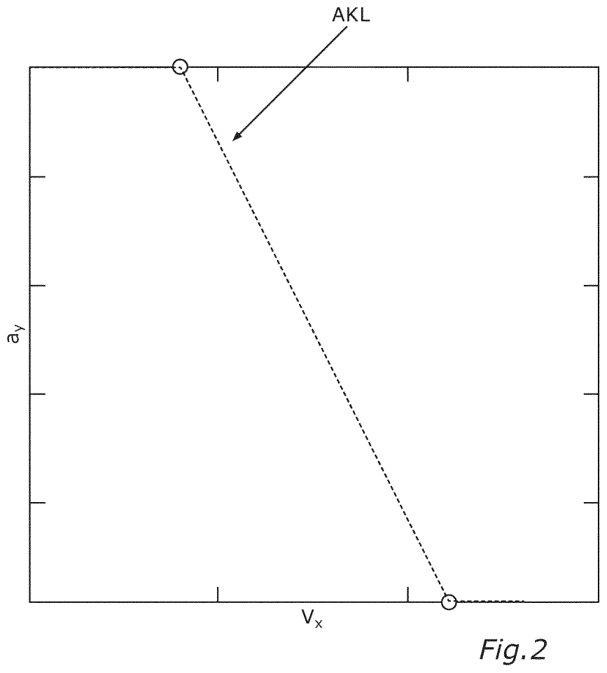

FIG. 2 shows a schematic representation of application characteristic curve data AKL. The application characteristic curve data AKL can describe a driving style-specific relationship between a transverse acceleration a_{y} and a vehicle speed vₓ. In FIG. 2, the vehicle speed vₓ is represented along the x axis. The transverse acceleration a_{y} is represented along the y axis. Such application characteristic curve data AKL can be used to iteratively determine a curve limiting speed v_{x, limit}.

The driving style-specific relationship between the transverse acceleration a_{y} and the vehicle speed vₓ shown in FIG. 2 can be summarized as follows: At lower speeds vₓ, higher transverse accelerations a_{y} can be observed. Vice versa, at higher speeds vₓ, lower transverse accelerations a_{y} can be observed. This can be explained, for example, by a lower risk consciousness at low speeds vₓ.

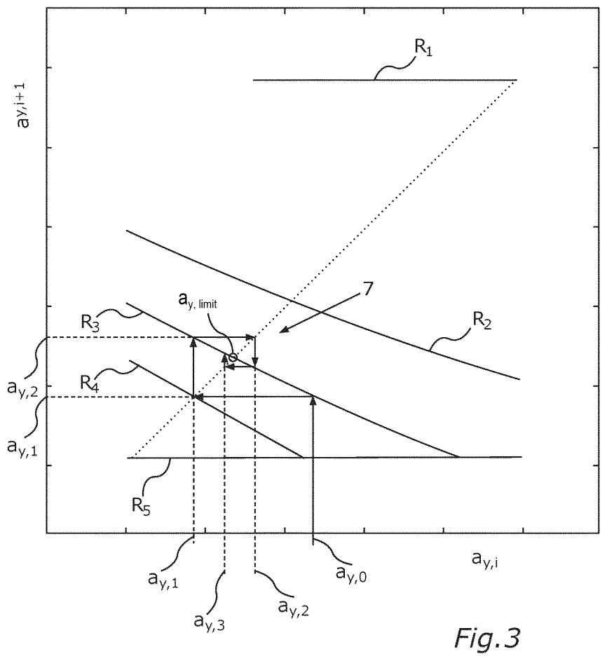

FIG. 3 shows a schematic representation of the iterative determination of the lateral limiting transverse acceleration a_{y, limit}. The curve limiting speed v_{x, limit} can then be determined on the basis of the lateral limiting transverse acceleration. The formula for centripetal acceleration (also radial acceleration) can be used here. Accordingly, the following applies as a function of the curve radius R

$${v}_{x , limit} = \sqrt{R \cdot {a}_{y , limit}}$$

FIG. 3 now shows the iterative determination of the lateral limiting transverse acceleration a_{y, limit} starting from an initial parameter a_{y, 0}, wherein a curve radius R₃, which can correspond to 200 meters, for example, is assumed. In the a_{y, i+1} a_{y}, diagram shown in FIG. 3, the curve radius R can also be shown.

The application characteristic curve data AKL can be represented, for example—as described in FIG. 2—as a function of the vehicle speed vₓ. According to the above formula, an iterative determination of the lateral limiting transverse acceleration a_{y, limit} can be defined by the application characteristic curve data AKL as a function of a vehicle speed vₓ, which can be derived within an iteration step according to the above formula from a previously determined transverse acceleration a_{y}. Expressed by formulas, an iterative determination of the lateral limiting transverse acceleration a_{y, limit} can thus be defined by

$${a}_{y , i + 1} = AKL ( {v}_{x} ) = AKL ( {v}_{x} ( {a}_{y , i} ) )$$

The above formula also supplies the graphs shown in FIG. 3 for different curve radii R₁, R₂, R₃, R₄, and R₅. Moreover, the iteration steps are shown by means of the indicated arrows 7.

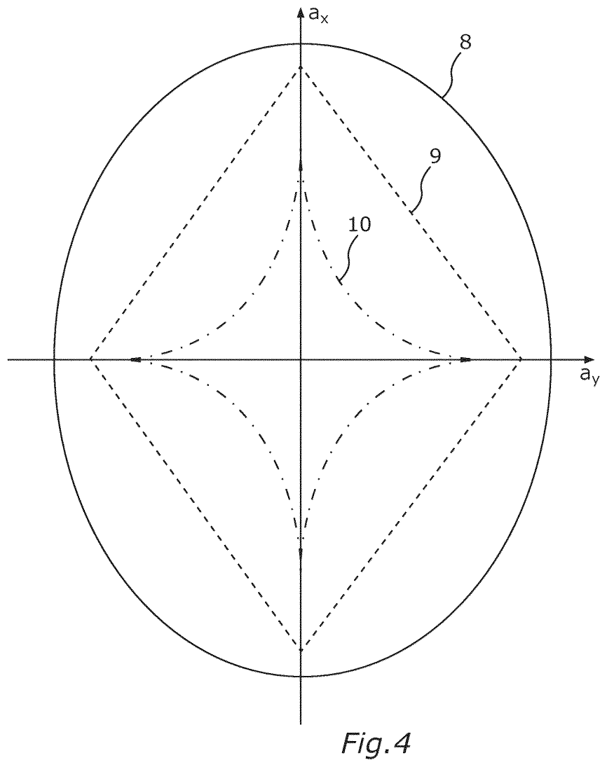

FIG. 4 shows a schematic representation of various driving styles extracted from (idealized) customer data. The longitudinal acceleration ax is plotted along the x axis and the lateral acceleration, thus the transverse acceleration a_{y}, is plotted along the y axis here. The circle or the ellipse 8 represents the so-called circle of forces. Acceleration data of a vehicle close to the ellipse 8 can indicate a sporty, dynamic driving style.

The parallelogram 9 can correspond to an average driving style. In contrast, the diamond shape 10 can indicate a comfort-oriented driving style. Such relationships or driving styles can be modeled or mapped by means of the application characteristic curve data AKL. The application characteristic curve data AKL for the method according to the invention can therefore be selected so that an individual and optimal curve limiting speed v_{x, limit} and/or an individual and optimal speed range can be determined depending on the driver desire and/or the personal driving style.

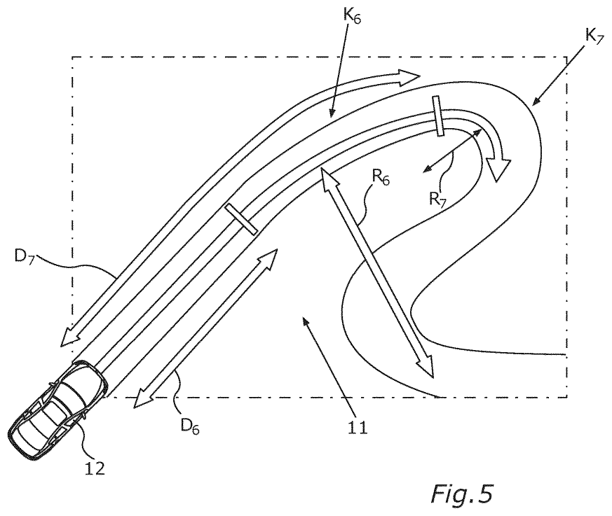

FIG. 5 is a schematic representation of a predetermined route 11 in road traffic having at least two successive curves K₆ and K₇, which are described by the curve radii R₆ and R₇ and by the curve distances D₆ and D₇. The vehicle 1 initially moves toward the curve K₆ here, wherein the curve K₆ can be classified as noncritical on the basis of the curve radius R₆ and the received driving dynamics data. The curve criticality of the curve K₆ can therefore be low.

The curve K₇ has a significantly smaller curve radius R₇—and therefore a higher curve curvature—but due to the curve distance D₇ is located even farther away from the vehicle than the curve K₆. If the route data describe at least two successive curves K₆ and K₇ to be traveled in future by the vehicle, an overall criticality can thus be determined which depends on the curve criticality of the curve K₆ and the curve criticality of the curve K₇—optionally in consideration of the curve distance D₆ and the curve distance D₇. As a result, a curve limiting speed v_{x, limit} or a speed range for the curve K₇ can already be recommended to the driver of the vehicle 1, although curve K₇ does not represent the immediately following curve. An analogous method can also be used for curves lying farther ahead.

1.-10. (canceled)

11. A method for supporting a driver of a vehicle in traveling a predetermined route in road traffic, the method comprising:
receiving route data, which describe at least one curve of the predetermined route to be traveled in future by the vehicle via a curve radius;
determining a curve limiting speed and/or a lateral limiting transverse acceleration, wherein the curve limiting speed or the lateral limiting transverse acceleration describes a maximum curve speed or a maximum lateral transverse acceleration as a function of the curve radius;
wherein application characteristic curve data are used to determine the curve limiting speed and/or the lateral limiting transverse acceleration, wherein the application characteristic curve data describe a driving style-specific relationship between a transverse acceleration and a vehicle speed.

12. The method according to claim 11, wherein
in the determination of the curve limiting speed and/or the lateral limiting transverse acceleration, an initial parameter is determined, wherein the initial parameter depends on the curve radius, and
the determination of the curve limiting speed and/or the lateral limiting transverse acceleration takes place iteratively starting from the initial parameter in consideration of the application characteristic curve data.

13. The method according to claim 11, wherein
additional driving dynamics data are received, which describe at least one current vehicle speed, and
a curve criticality of the at least one curve of the predetermined route to be traveled in the future by the vehicle is determined as a function of the driving dynamics data and the curve limiting speed and/or the lateral limiting transverse acceleration.

14. The method according to claim 12, wherein
additional driving dynamics data are received, which describe at least one current vehicle speed, and
a curve criticality of the at least one curve of the predetermined route to be traveled in the future by the vehicle is determined as a function of the driving dynamics data and the curve limiting speed and/or the lateral limiting transverse acceleration.

15. The method according to claim 13, wherein
the route data describe at least two successive curves to be traveled in the future by the vehicle via the curve radius and a curve distance, and
an overall criticality is determined, which depends on the curve criticality of the at least two successive curves and the respective curve distance of the at least two successive curves.

16. The method according to claim 14, wherein
the route data describe at least two successive curves to be traveled in the future by the vehicle via the curve radius and a curve distance, and
an overall criticality is determined, which depends on the curve criticality of the at least two successive curves and the respective curve distance of the at least two successive curves.

17. The method according to claim 11, wherein recommendation data are provided which describe a speed range, wherein the speed range comprises the curve limiting speed.

18. The method according to claim 12, wherein recommendation data are provided which describe a speed range, wherein the speed range comprises the curve limiting speed.

19. The method according to claim 13, wherein recommendation data are provided which describe a speed range, wherein the speed range comprises the curve limiting speed.

20. The method according to claim 18, wherein the recommendation data additionally or alternatively describe the curve criticality and/or the overall criticality.

21. The method according to claim 19, wherein the recommendation data additionally or alternatively describe the curve criticality and/or the overall criticality.

22. A computing device for a vehicle, the computing device being configured to carry out a method according to claim 11.

23. A non-transitory computer-readable medium including commands, which, upon execution by a computing device, cause the computing device to carry out a method according to claim 11.

24. An assistance system for a vehicle, the assistance system comprising:
a computing device configured to carry out a method according to claim 11;
a non-transitory computer-readable medium including commands, which, upon execution by the computing device, cause the computing device to carry out the method; and
a notification device configured to output recommendation data to the driver, the recommendation data describing a speed range that includes the curve limiting speed.

25. The assistance system according to claim 24, wherein the notification device is configured to output the recommendation data to the driver as a notification and to visually display the predetermined route to the driver, wherein at least a part of the notification is colored depending on the criticality and/or the overall criticality.
